(19) United States
(12) Patent Application Publication
(10) Pub. No.: US 2026/0308052 A1
(43) Pub. Date: Oct. 8, 2026

(54) METHOD OF PROCESSING ROADWAY MATERIAL TO PREVENT OR REDUCE CRACKING AND/OR DETERIORATION

(71) Applicant: Billy Shane McDade, Lakeway, TX (US)

(72) Inventor: Billy Shane McDade, Lakeway, TX (US)

(21) Appl. No.: 19/641,155

(22) Filed: Apr. 7, 2026

Related U.S. Application Data
(60) Provisional application No. 63/784,590, filed on Apr. 7, 2025.

(51) Int. Cl. C04B 7/13; C04B 26/26; C04B 103/00; E01C 23/06

(52) U.S. Cl. CPC C04B 7/13; C04B 26/26; C04B 2103/0092; E01C 23/065

(57) ABSTRACT

Embodiments can relate to a method of preparing roadway material. The method can involve combining an aggregate and a cement-based binder to form an untreated roadway mix. The method can involve adding a crack mitigating agent to the untreated roadway mix to generate a treated roadway mix. The crack mitigating agent can include maltenes and the addition of it to the untreated roadway mix can influence dispersion of the cement, formation of calcium hydroxide (CH) and/or calcium silicate hydrate (CSH), and/or flexibility of the treated roadway mix.

### CROSS-REFERENCE TO RELATED APPLICATIONS

This patent application is related to and claims the benefit of priority to U.S. provisional patent application No. 63/784,590, filed on Apr. 7, 2025, the entire contents of which is incorporated herein by reference.

### FIELD OF INVENTION

The present disclosure relates to cement-stabilized roadway materials, and more particularly to the use of a soft asphalt emulsion containing maltenes in conjunction with Portland cement to mitigate cracking tendency in cement-treated roadway materials.

### BACKGROUND

Base stabilization is a common method used for roadway repair and construction to improve the structural load-bearing capacity, durability, and moisture resistance of road foundations (e.g., brushed stone base material). Base stabilization typically involves adding a stabilizing binder (e.g., cement, asphalt emulsion, lime, etc.) to the crushed stone base material during a pug mill operation, a Full Dept Reclamation (FDR) process, etc. A pug mill process typically involves use of a mixer to blend aggregate, water, asphalt emulsion, cement, etc. to create a desired base material. An FDR process typically involves pulverizing old Hot Mix Asphalt (HMA) pavement and crushed stone road base material (e.g., existing roadway material) together in a reclaimer machine and mixing the resultant material with binder, additives, water, etc. to generate new roadway material that can be used for new pavement to replace the old pavement. These processes can also be used to upgrade virgin crushed stone road base material. These processes typically generate an improved road base material that exhibits material properties that are better than those of the original roadway material.

Asphalt and cement, and in particular Portland cement, are commonly used binders used in the stabilization process. Using cement as a binder is generally less expensive than using asphalt, and cement creates a very strong roadway material with high compressive strength. However, roadway materials stabilized with only cement as a binder are very rigid, and become even more rigid over time as the cement continues to cure. This rigidity makes cement-stabilized roadway materials prone to premature cracking and shrinkage cracks. Using asphalt as a binder can involve using it in emulsion form (e.g., liquid mix of asphalt, water, emulsifier, etc.) or foamed form (a foam formed by injecting water into hot bitumen). When asphalt is the primary binder, a small amount of cement can be added to the mixture to add strength to the resultant roadway material, to assist with curing of the asphalt emulsion, etc. Roadway mixes stabilized with cement as the sole or primary binder can be referred to as cement-stabilized roadway mixes. Roadway mixes stabilized with asphalt as the sole or primary binder can be referred to as asphalt-stabilized roadway mixes.

There is a tradeoff regarding the use of cement or the use of asphalt as the binder in the stabilization process. This tradeoff is associated with balancing strength, stiffness, durability, curing time, etc. of roadway mixes. Cement-stabilized roadway mixes may be prone to excessive cracking and premature deterioration, whereas asphalt-stabilized roadway mixes may be susceptible to deformation and moisture damage. Additional factors in balancing the variables associated with this tradeoff include weather, traffic volume, load, etc., which typically demand roadway material exhibiting high stiffness to ensure good-performing and long-lasting pavements. Various techniques have been attempted to mitigate cracking in cement-stabilized roadway mixes, such as microcracking before complete curing. However, microcracking involves an additional construction step, which can add to costs, complexity inefficiencies, etc. In addition, microcracking is not reliable.

Therefore, there is a need for an optimized mix that could provide high stiffness while being resistant to cracking.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to an aspect of the present disclosure, a method for mitigating cracking tendency (e.g., cracking caused by shrinkage, moisture infiltration, heavy traffic loads, oxidation from age, freezing/thawing cycles, etc.) of cement-treated roadway materials is provided. The method can include combining roadway material with cement as a primary binder to form a cement-stabilized mixture. The method can further include adding an asphalt emulsion containing maltenes to the cement-stabilized mixture as a crack-mitigating additive. The techniques disclosed herein are distinct from known methods of adding cement to an asphalt-stabilized base to improve strength or curing. In contrast to these known methods, cement is used to serve as the primary strength-providing binder while a crack mitigating agent is added to resist cracking, provide more uniformity in material properties, improve curing, etc., thereby making the cement-stabilized mixture less crack-prone.

An exemplary embodiment can relate to a method of preparing roadway material. The method can involve combining an aggregate and a binder to form an untreated roadway mix. The binder can include cement. The method can involve adding a crack mitigating agent to the untreated roadway mix to form a treated roadway mix. The crack mitigating agent can include maltenes, the amount of maltenes within the crack mitigating agent being 0.01%-5% by weight of the untreated roadway mix.

The aggregate can include one or more types of aggregate. The binder can include one or more types of binder.

The crack mitigating agent can be added during and/or after the aggregate and the binder are combined to form the untreated roadway mix.

The aggregate can include stone, gravel, crushed concrete, and/or recycled asphalt pavement (RAP).

The binder can include asphalt.

The cement can include Portland cement.

The cement in the binder can be at least 1% by weight of the untreated roadway mix.

The crack mitigating agent can be an emulsion.

The emulsion can include water, asphalt, and maltenes.

The emulsion can be 1%-60% maltenes by weight of the emulsion.

The crack mitigating agent can be added to the roadway mix all at once, in a gradual adding process, or in an iterative process.

An exemplary embodiment can relate to a method of conditioning an untreated roadway mix. The method can involve adding a crack mitigating agent to an untreated roadway mix. The crack mitigating agent can include maltenes, the mount of maltenes within the crack mitigating agent being 0.01%-5% by weight of the untreated roadway mix. The untreated roadway mix can include a binder or a binder is added to the untreated roadway mix prior to adding the crack mitigating agent. The binder can include cement.

The untreated roadway mix can be or include a cement-stabilized roadway mix.

The untreated roadway mix can include recycled asphalt pavement (RAP) and/or aggregate base course.

The aggregate base course can include stone, gravel, and/or crushed concrete.

The untreated roadway mix can include recycled asphalt pavement (RAP) and aggregate base course.

The untreated roadway mix can have a greater percentage of aggregate base course than that of RAP.

The method can involve adding water to the treated roadway mix such that a moister content of the treated roadway mix is greater than the predetermined optimum moister content of the untreated roadway mix.

An exemplary embodiment can relate to a method of processing roadway material. The method can involve reclaiming one or more layers of roadway material comprising an asphalt layer and a base course layer to form an untreated roadway mix. The method can involve adding a binder comprising cement to the untreated roadway mix. The method can involve adding maltenes to the untreated roadway mix to generate a treated roadway mix by influencing: dispersion of the cement in the treated roadway mix; formation of calcium hydroxide (CH) and/or calcium silicate hydrate (CSH) in the treated roadway mix; and/or flexibility of the treated roadway mix.

The foregoing general description of the illustrative embodiments and the following detailed description thereof are merely exemplary aspects of the teachings of this disclosure and are not restrictive.

### BRIEF DESCRIPTION OF FIGURES

Non-limiting and non-exhaustive examples are described with reference to the following figures.

FIG. 1 shows an exemplary process flow diagram that can be used to carry out an embodiment of the method in which base stabilization is being performed during a Full Depth Reclamation process.

FIG. 2 shows an exemplary process flow diagram that can be used to carry out an embodiment of the method in which base stabilization is being performed during a pugmill process.

FIG. 3 shows main steps in the crack detection and calculation of crack statistics.

FIG. 4 shows average and standard deviation values of UCS of mixes; Cement content: 5%.

FIG. 5 shows peak intensity of CSH and CH of mixes, relative to 7-days cured samples; Cement content: 5%.

FIG. 6 shows average and standard deviation values of UCS of mixes; Cement content: 5%. Note: 3 hC: 3 hours curing; RT: Room temperature/countertop curing; MC: moisture conditioning; 1 sample (each) tested for 3 hC_7dRT and 3 hC_24hRT

FIG. 7 shows average and standard deviation values of UCS of mixes without EE, and with 0.5% and 1.5% EE; Cement content: 5%; Note: 1dC: 1 day curing; MC: moisture conditioning.

FIG. 8 shows peak intensity of CSH and CH of mixes, relative to mix without EE; Cement content: 5%; 1-day curing.

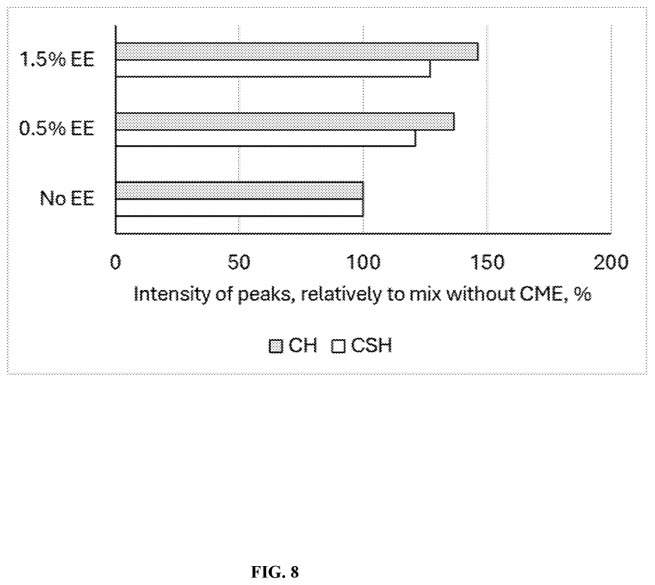

FIG. 9 shows average and standard deviation values of UCS of mixes without EE, and with 1% EE; Cement content: 5%; Note: 7dC: 7-day curing; MC: moisture conditioning.

FIG. 10 shows peak intensity of CSH and CH of mixes, relative to mix without EE; Cement content: 5%; 7-day curing.

FIG. 11 shows probability density and 95^{th} percentile values from Montecarlo simulations; The μ and σ values above each plot indicate the mean and standard deviation of the resilient modulus values.

FIG. 12 shows plot of peak intensity of CSH and UCS; Regression with non-EE mixes only.

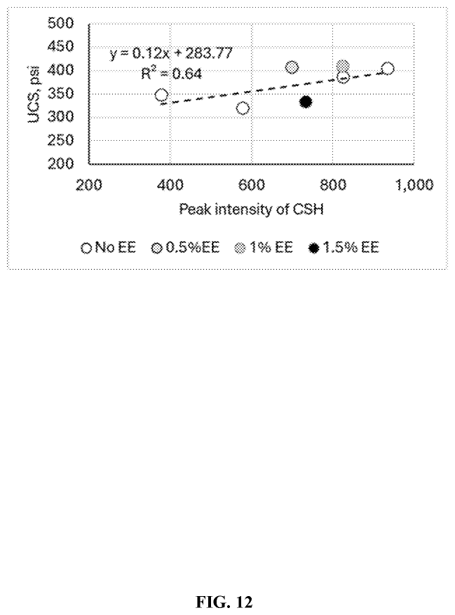

FIG. 13 shows plot of peak intensity of CH and UCS; Regression with non-EE mixes only.

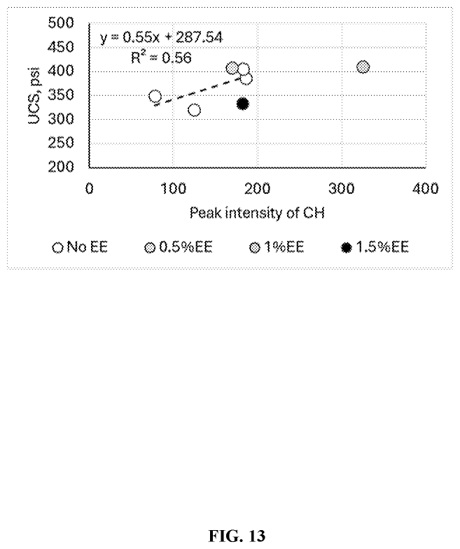

FIG. 14 shows images of mixes cured for 24 hours with a) no EE; b) 0.5% EE; c) 1.5% EE.

FIG. 15 shows images of mixes cured for 7-day cure with a) no EE; b) 1% EE

FIG. 16 shows number of cracks of different mixes; Cement content: 5%; Note: 1dC: 1 day cure; MC: moisture conditioning; EE: crack mitigator emulsion.

FIG. 17 shows median crack length of different mixes; Cement content: 5%; Note: 1dC: 1 day cure; MC: moisture conditioning; EE: crack mitigator emulsion.

FIG. 18 shows typical type 3 failure mode for all mixes (figure on right redrawn from ASTM C39/C39M-21.

FIG. 19 shows shrinkage cracking potential of adding crack mitigating agent.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

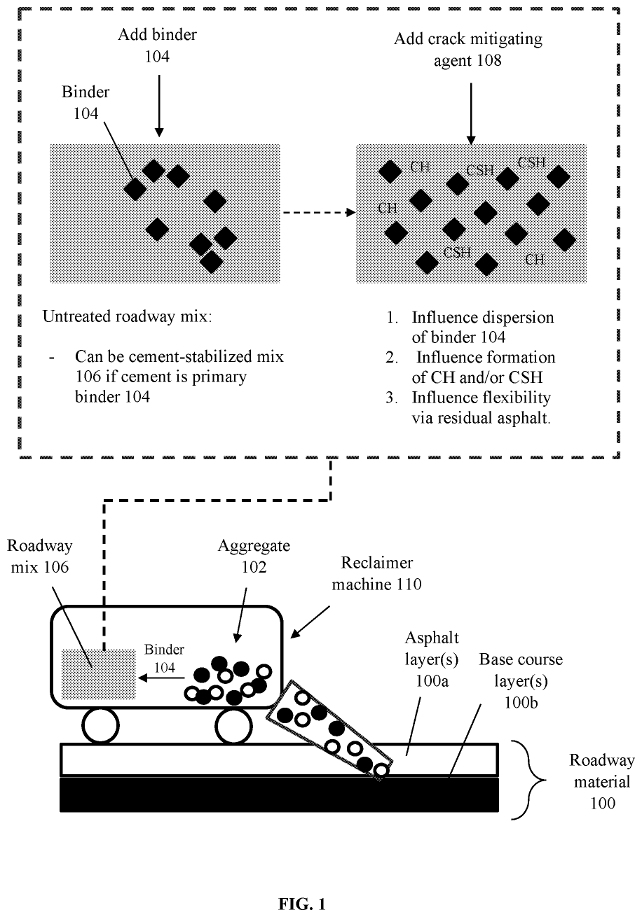

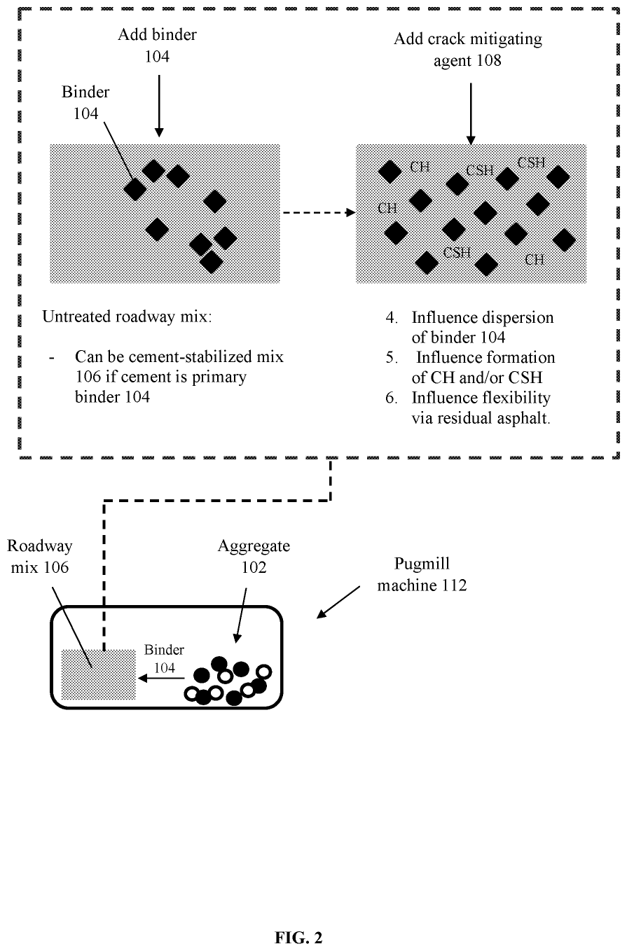

Referring to FIGS. 1-2, embodiments can relate to a method of preparing roadway material 100. The method can involve combining an aggregate 102 (e.g., crushed stone base material) and a binder 104 (e.g., asphalt, cement, etc.) to form a roadway mix 106, and adding a crack mitigating agent 108 to the roadway mix 106 to prevent, reduce the effects of, or reduce the amount of cracks and deterioration—e.g., the method can involve adding both the binder 104 and the crack mitigating agent 108. In the alternative, the method can involve adding a crack mitigating agent 108 to a roadway mix 106 that had already been prepared (the roadway mix 106 comprising to aggregate 102 and a binder 104) to prevent, reduce the effects of, or reduce the amount of cracks and deterioration—e.g., the method can involve only adding crack mitigating agent 108 to a roadway mix 106 in which the aggregate 102 and the binder 104 had already been mixed together to form the roadway mix 106. A roadway mix 106 comprising of aggregate 102 mixed with binder 104 can be referred to herein as an untreated roadway mix 106. A roadway mix 106 in which crack mitigating agent 108 has been added can be referred to herein as treated roadway mix 106. The untreated roadway mix 106 is the stabilized roadway mix 106 that has been stabilized via the addition of binder 104. If the binder 104 used for stabilization is cement (or primarily cement) then the untreated roadway mix 106 can be referred to as cement-stabilized roadway mix 106, if the binder 104 used for stabilization is asphalt (or primarily asphalt) then the untreated roadway mix 106 can be referred to as asphalt-stabilized roadway mix 106, if the binder 104 used for stabilization is lime (or primarily lime) then the untreated roadway mix 106 can be referred to as lime-stabilized roadway mix 106, etc. The untreated roadway mix 106 can be formed via a FDR process (see FIG. 1), a pugmill process (see FIG. 2), etc. While it is not necessary to do so, it is contemplated for the crack mitigation agent 108 to be added at the same time as when the binder 104 is added. Therefore, the treated roadway mix 106 can also be formed via the FDR process, pugmill process, etc.

It is contemplated for the roadway material 100 to be used as a roadway base material. It is further contemplated for the roadway material 100 to be comprised of (either partially or fully) virgin or recycled crushed stone road base, and (either partially or fully) reclaimed pavement or recycled asphalt pavement (RAP). This reclamation process can be via the FDR process, pugmill process, etc. The reclamation process can involve adding cement as the binder 104 for stabilization purposes, and therefore the addition of crack mitigating agent(s) 108 to the untreated roadway mix 106 can mitigate the effects of rigidity as the roadway material 100 cures. These effects to be mitigated can include premature cracking, shrinkage cracking, other types of cracking, deterioration, etc.

The aggregate 102 can be or include virgin or recycled stone, virgin or recycled gravel, crushed concrete, RAP, etc. For reclaimed roadway mixes 106, aggregate 102 can be generally segmented into two groups: 1) aggregate base course (e.g., limestone material, gravel, stone, crushed concrete, etc.); and 2) reclaimed asphalt (e.g., RAP). Any portion of the aggregate base course can be virgin or recycled. The roadway mix 106 can include one or more aggregates 102. For instance, the method can involve combining an aggregate 102 comprising a first aggregate, a second aggregate, a third aggregate, etc. with a binder 104. The first aggregate can be the same or different type of aggregate as the second aggregate, the same or different type of aggregate as the third aggregate, etc. For instance, the aggregate 102 can include a first aggregate of stone and a second aggregate of crushed concrete. The first aggregate can be the same type of aggregate as the second aggregate but of a different variety, the same type of aggregate as the third aggregate but of a different variety, etc. For instance, the aggregate 102 can include a first aggregate of Grade 3-gravel and a second aggregate of Grade-5 gravel. The first aggregate can be present in an amount that is the same or different from that of the second aggregate, be present in an amount that is the same or different from that of the third aggregate, etc. For instance, the aggregate 102 can include a first aggregate of aggregate base course and a second aggregate of RAP, wherein the ratio of the first aggregate to the second aggregate can be 5% to 95%, 10% to 90%, 15% to 85%, 20% to 80%, 25% to 75%, 30% to 70%, 35% to 65%, or any other ratio, etc.

The roadway mix 106 can include one or more binders 104. These binders 104 are used for stabilization—e.g., to generate untreated roadway mixes 106 that are cement-stabilized roadway mixes 106, asphalt-stabilized roadway mixes 106, lime-stabilized roadway mixes 106, etc. The binder 104 can be present in an amount such that it comprises up to 25% by weight of the untreated roadway mix 106. Exemplary binders 104 can include asphalt (e.g., bitumen, polymer-modified binder, rubber binder, emulsified asphalt, cutback asphalt, etc.), cement (e.g., asphalt cement, Portland cement, etc.), lime, etc. The method can involve combining an aggregate 102 with a binder 104 comprising a first binder, a second binder, etc. The first binder can be the same or different type of binder as the second binder, the same or different type of binder as the third binder, etc. For instance, the binder 104 can include a first binder of cement and a second binder of asphalt. The first binder can be the same type of binder as the second binder but of a different variety, the same type of binder as the third binder but of a different variety, etc. For instance, the binder 104 can include a first binder of a first type of Portland cement and a second binder of a second type of Portland cement. The first binder can be present in an amount that is the same or different from that of the second binder, be present in an amount that is the same or different from that of the third binder, etc. For instance, the binder 104 can include a first binder of cement and a second binder of asphalt, wherein the ratio of the first binder to the second binder can be 5% to 95%, 10% to 90%, 15% to 85%, 20% to 80%, 25% to 75%, 30% to 70%, 35% to 65%, or any other ratio, etc.

It is contemplated for the aggregate 102 to include reclaimed aggregate material or recycled aggregate pavement (e.g., RAP) that has been reclaimed via an FDR process, a pugmill process, etc. As noted herein, untreated roadway mixes 106 can be cement-stabilized FDR roadway mixes 106, asphalt-stabilized roadway mixes 106, lime-stabilized roadway mixes 106, etc. Cement-stabilized roadway mixes 106 can be characterized as untreated roadway mixes 106 in which the binder 104 includes cement. The cement can be the sole component of the binder 104 or a partial component of the binder 104, but the defining characteristic is for the cement to be the primary binder for stabilization—i.e., the cement is the component of the binder that primarily (e.g., more so than any other component) contributes to the stabilization (strength, durability, and load-bearing capacity) of the untreated roadway mix 106. The amount of cement in the binder 104 to constitute the untreated roadway mix 106 as being a cement-stabilized roadway mix 106b depends on the constituents of the untreated roadway mix 106 and the binder 104. For an untreated roadway mix 106 composed of 70% aggregate base course and 30% RAP, the amount of cement present in the binder 104 to make the untreated roadway mix 106 a cement-stabilized roadway mix 106 can be from 0.01% to 20% by weight of the untreated roadway mix 106. It is contemplated for the amount of cement to be between 3% and 8% by weight of the untreated roadway mix 106, but it can fall with the range between 0.01% and 20%. Such a cement content can yield a moisture-conditioned unconfined compressive strength (UCS) for the roadway material 100 in the range of about 300 psi to about 500 psi after 7 days of curing. Asphalt-stabilized roadway mixes 106 can be characterized as untreated roadway mixes 106 in which the binder 104 includes asphalt. The asphalt can be the sole component of the binder 104 or a partial component of the binder 104, but the defining characteristic is for the asphalt to be the primary binder for stabilization—i.e., the asphalt is the component of the binder that primarily (e.g., more so than any other component) contributes to the stabilization (strength, durability, and load-bearing capacity) of the untreated roadway mix 106. For an untreated roadway mix 106 composed of 70% aggregate base course and 30% RAP, the amount of asphalt present in the binder 104 to make the untreated roadway mix 106 an asphalt-stabilized roadway mix 106 can be from 0.01% to 20% by weight of the untreated roadway mix 106. It is contemplated for the amount of asphalt to be between 3% and 8% by weight of the untreated roadway mix 106, but it can fall with the range between 0.01% and 20%. Lime-stabilized roadway mixes 106 can be characterized as untreated roadway mixes 106 in which the binder 104 includes lime. The lime can be the sole component of the binder 104 or a partial component of the binder 104, but the defining characteristic is for the lime to be the primary binder for stabilization—i.e., the lime is the component of the binder that primarily (e.g., more so than any other component) contributes to the stabilization (strength, durability, and load-bearing capacity) of the untreated roadway mix 106. For an untreated roadway mix 106 composed of 70% aggregate base course and 30% RAP, the amount of lime present in the binder 104 to make the untreated roadway mix 106 a lime-stabilized roadway mix 106 can be from 0.01% to 20% by weight of the untreated roadway mix 106. It is contemplated for the amount of lime to be between 3% and 8% by weight of the untreated roadway mix 106, but it can fall with the range between 0.01% and 20%.

The inventive method involves mitigating the effects of rigidity of roadway material 100 made from cement-stabilized roadway mixes 106b; therefore, it is contemplated for the untreated roadway mix 106 to be or at least include cement-stabilized roadway mix 106. The entire untreated roadway mix 106 can be cement-stabilized roadway mix, or the cement-stabilized roadway mix can form a component of the untreated roadway mix 106, etc. For instance, the untreated roadway mix 106 can be composed entirely of an aggregate 102 and a binder 104 in which the binder 104 contains an amount of cement to characterize the untreated roadway mix 106 as a cement-stabilized roadway mix 106. Alternatively, the roadway mix 106 can include a combination of a first roadway mix 106 (composed of cement-stabilized roadway mix 106) and a second roadway mix 106 (composed of an asphalt-stabilized roadway mix or some other type of roadway mix 106).

The method can involve adding one or more crack mitigating agents 108 to the untreated roadway mix 106. Upon adding the crack mitigating agent 108 to the untreated roadway mix 106, the resultant roadway mix 106 can be referred to as treated roadway mix 106. The crack mitigating agent 108 can be added while the aggregate 102 and the binder 104 are combined to form the untreated roadway mix 106, the crack mitigating agent 108 can be added after the aggregate and the binder 104 are combined to form the untreated roadway mix 106, or a combination thereof. The crack mitigating agent 108 can be an emulsion. The emulsion can include water, asphalt, and maltenes. The component of the crack mitigating agent that prevents, reduces the effects of, or reduces the amount of cracks and deterioration is the maltenes; therefore, any crack mitigating agent 108 should include an amount of maltenes (petroleum-based, bio-based) or equivalents thereof. While the amount of maltenes in the crack mitigating agent 108 can be any amount, it is contemplated for the amount of maltenes present in the emulsion to be 1%-60% maltenes by weight of the emulsion, and can preferably be approximately 20% maltenes by wight of the emulsion. An exemplary emulsion composition can include 35% water, 40% asphalt, and 25% maltenes. While it is contemplated for the maltene load to be added in a form of an emulsion, it is understood that it need not be. For instance, the crack mitigating agent 108 need not be formulated as an emulsion containing maltenes, but rather the crack mitigating agent 108 can consist of maltenes which is added to the roadway mix 106. The amount of maltenes to be added to the roadway mix 106 depends on the on the constituents of the roadway mix 106 and the binder 104, but the amount of maltenes added should not be too much as an excess amount of maltenes can undesirably soften the roadway mix 106.

While it is contemplated for the crack mitigating agent 108 to be added to the untreated roadway mix 106 at the same time as the binder 104 is being added, it need not be. In addition, the crack mitigating agent 108 can be added all at once (e.g., the desired amount of crack mitigating agent 108 can be added to the roadway mix 106 as a single step), added gradually (e.g., added slowly but continuously), in iterations (e.g., the crack mitigation agent 108 can be added in increments of amounts until a desired amount of crack mitigating agent 108 is added to the roadway mix 106), etc. The roadway mix 106 with the added crack mitigating agent 108 (e.g., the treated roadway mix 106) can be agitated (e.g., mechanically stirred) to disperse and mix the crack mitigating agent 108 throughout the roadway mix 106.

One of the tradeoffs to be balanced can be curing time. Generally, adding maltenes can have an effect of increasing curing time. This can be balanced (if desired) by adding water to the roadway mix 106. The water can be added to the aggregate 102, to the binder 104, to the crack mitigating agent 108, etc. Generally, the higher the water-to-cement ratio is for a cement-stabilized FDR roadway mix 106ba, the shorter the time is required for curing. Thus, it may be preferred to have a moister content within the treated roadway mix 106 that is greater than the moister content of the untreated roadway mix 106.

The inventive technique can be used to condition untreated roadway mixes 106; therefore, embodiments can relate to a method of conditioning an untreated roadway mix 106. The untreated roadway mix 106 can be generated via an FDR process, a pugmill process, etc. The FDR process can involve pulverizing and mixing existing roadway material 100 in a reclaimer machine 110. The reclaimer machine 110 can also be configured to repave the road with the new roadway mix. Reclaimer machines 110 typically include a rotating drum with teeth to grind the old roadway material 100 and blend in a mixer it to generate RAP. The RAP can be used as the aggregate 102 for the untreated roadway mix 106 or combined with additional aggregate 102 to generate the untreated roadway mix 106. One or more binders 104 can be added to the untreated roadway mix 106, which can include adding cement to generate a cement-stabilized roadway mix 106. The binder 104 can be added to the untreated roadway mix 106 in the mixer of the reclaimer machine 110. The method can involve adding a crack mitigating agent 108 to the untreated roadway mix 106 in any of the manners prescribed herein, thereby generating treated roadway mix 106. The binder 104 can be added to the untreated roadway mix 106 prior to and/or while adding the crack mitigating agent 108, crack mitigating agent 108 can be added to the roadway mix 106 prior and/or while adding binder 104 to the roadway mix 106, etc.

The pugmill process can involve receiving pulverized existing roadway material 100 in a hopper and mixing it in a mixer of a pugmill machine 112 to generate untreated roadway mix 106. One or more binders 104 can be added to the untreated roadway mix 106, which can include adding cement to generate a cement-stabilized roadway mix 106. The method can involve adding a crack mitigating agent 108 to the untreated roadway mix 106 in any of the manners prescribed herein, thereby generating treated roadway mix 106. The binder 104 can be added to the untreated roadway mix 106 prior to and/or while adding the crack mitigating agent 108, crack mitigating agent 108 can be added to the roadway mix 106 prior and/or while adding binder 104 to the roadway mix 106, etc.

As can be appreciated, methods disclosed herein can relate to one or more processing techniques applied to roadway material 100. With embodiments contemplated for processing reclaimed roadway mixes 106, the method can involve reclaiming one or more layers of a roadway material 100. The roadway material 100 can comprise one or more asphalt layers 100a and one or more base course layers 100b, which can include one or more asphalt layers 100a on top of one or more base course layers 100b. Reclamation can be done via an FDR process, a pugmill process, etc. to form untreated roadway mix 106 comprising one or more asphalt layers 100a, one or more base course layers 100b, two or more layers comprising at least one asphalt layer 100a and at least one base course layer 100b, etc. Depending on the original structure and number and thickness of layers of the old pavement, the reclamation process can reclaim from 4 inches to 20 inches of the old pavement. One or more binders 104 can be added to the untreated roadway mix 106. This can be done to generate a cement-stabilized roadway mix 106. A crack mitigating agent 108 composed of or including maltenes can be added to the cement-stabilized roadway mix 106. The crack mitigating agent 108 can be added to influence (e.g., promote, facilitate, enhance, improve, serve as a catalyst for, etc.) dispersion of the cement in the FDR roadway mix 106. In addition, or in the alternative, the crack mitigating agent 108 can be added to influence (e.g., promote, facilitate, enhance, improve, serve as a catalyst for, etc.) formation of calcium hydroxide (CH) and/or calcium silicate hydrate (CSH). In addition, or in the alternative, the crack mitigating agent 108 can be added to influence flexibility via incorporation of residual asphalt via the addition of maltenes. Influencing dispersion of the cement in the treated roadway mix 106, influencing formation of CH and/or CSH in the treated roadway mix 106, and/or influencing flexibility in the treated roadway mix 106 can mitigate the effects of rigidity as the treated roadway mix 106 cures. Influencing dispersion can include facilitating a more uniform distribution of cement within the treated roadway mix 106 matrix, which can result in more uniform unconfined compressive strength (UCS). Notably, this can be achieved without lowering the average UCS of the roadway material 100—e.g., adding the crack mitigating agent 108 can cause the roadway material 100 comprising the treated roadway mix 106 to have a more uniform UCS without reducing the average UCS of the roadway material 100. Test results show that the standard deviation of UCS of a cement-stabilized roadway mix 106 without addition of a crack mitigating agent 108 is 114 psi, whereas the standard deviation of UCS of a similarly formulated cement-stabilization roadway mix 106 with the addition of a crack mitigating agent 108 is 49 psi. Test results further show that addition of an emulsion containing an amount of maltenes reduces the standard deviation of UCS to 7 psi. Influencing formation of CH and/or CSH can include facilitating hydration, which can contribute to increased strength of the roadway material 100—e.g., adding the crack mitigating agent 108 can cause the roadway material 100 comprising the treated roadway mix 106 to form hydration products (e.g., CH, CSH, etc.) or more hydration products than otherwise would be formed. These mechanisms are what lead to prevention or reduction of the amount of cracks and deterioration.

The more uniform UCS and/or formation of hydration products can also reduce crack length of cracks that will form in the resultant pavement roadway material 100 as it cures. Test results show that the median crack length of a cement-stabilized roadway mix 106 without addition of a crack mitigating agent 108 is 19 mm, whereas the median crack length of a similarly formulated cement-stabilization roadway mix 106 with the addition of a crack mitigating agent 108 is 3 mm. Test results further show that addition of an emulsion containing an amount of maltenes reduces the median crack length to 8 mm.

In addition, test results show that the addition of crack mitigating agent(s) 108 can prevent or reduce the likelihood of a concentration crack formation, thereby improving the durability and performance of the cement-stabilized roadway material 100. The cracking tendency of a cement-stabilized roadway mix 106 can be evaluated according to AASHTO T334, which is a standard method for estimating the cracking tendency of concrete materials. Under this test protocol, specimens are compacted to about 95% to about 100% of modified Proctor density. The test duration can be a minimum of 5 days, with continuous steel strain recording. Performance requirements may include: age at cracking of 3 days or greater, maximum restrained tensile stress of 0.60 times the 7-day indirect tensile strength or less, and maximum steel strain of 250 microstrain or less at 5 days.

Test results further show that cement-stabilized roadway mixes 106 containing maltenes exhibit a significant reduction in strain (e.g., approaching almost zero), as compared to conventional cement-stabilized FDR roadway mixes, indicating much lower tensile stress and hence cracking prevention potential.

### Examples

The following examples relate to test results demonstrating the effectiveness of the adding a crack mitigating agent 108.

Cement-stabilized Full Depth Reclamation (FDR) presents a sustainable method of asphalt pavement rehabilitation. This study investigated the use of different curing periods and explored the potential of improving the properties of cement-FDR mixes with the use of Engineered Emulsion (EE) with high maltene content. Samples were cured for different durations and moisture conditioned, and tested for unconfined compressive strength (UCS), and selected samples were tested with X Ray Diffraction (XRD) method to evaluate the formation of CH and CSH. Image analysis was conducted to compare the cracking potentials of the different mixes. The results show that the mixes cured for shorter durations may possess similar moisture-conditioned strength as those cured for the standard 7-day period. The use of EE can result in a significant reduction of standard deviation (variability) of UCS results, and a reduction in the median length of shrinkage cracks. The presence of EE can also enhance the formation of CH and CSH in the cement-FDR mixes. A comprehensive field study is recommended to further explore the use of EE as a crack mitigator and to help in the better dispersion of cement and reduction of variability in cement-FDR mixes.

### Introduction

Full Depth Reclamation (FDR) is a sustainable asphalt pavement rehabilitation method with several benefits, including reduced materials, energy, and cost, as well as lower emissions. In this method, the existing asphalt pavement layers are recycled along with a predetermined thickness of the underlying layer to obtain a new base layer over which typically one or two layers of asphalt mix (Hot Mix Asphalt, HMA) are placed.

Asphalt, in the form of emulsion or foamed asphalt, and Portland cement are the two main stabilizers that are used in FDR. There are advantages and disadvantages for both types of stabilizers, and each one is appropriate for use in specific conditions. A common concern is the relatively high variability of materials and construction, and hence resultant base layer properties.

In cement-FDR, the strength of the mix (typically measured by Unconfined Compressive strength, UCS) is kept below a limit (depending on specifications) to avoid the potential of cracking caused by excessive brittleness, which may lead to a reduction in strength. Furthermore, adequate curing, up to 7 days, is required to allow for sufficient strength gain, especially when heavy traffic is expected.

In asphalt-based FDR, a relatively small amount of cement (typically, <2%) is often utilized as active filler to enhance the dispersion of the binder and develop early strength. Recent use of engineered emulsions, such as those with high maltene content, has proven to be more beneficial compared to conventional emulsions (such as CSS1H) to achieve adequate levels of strength.

There are two hypotheses on which the current study is based. First, cement-FDR mixes, with relatively low cement/water or high water/cement ratio, may require a shorter curing period than the standard 7-day curing to develop adequate strength. The second hypothesis is that instead of relying on asphalt emulsion in relatively low amounts (compared to asphalt content of Hot Mix Asphalt, HMA) to provide strength, and Portland cement in very small amounts to aid in dispersion and early strength, an opposite approach consisting of a relatively high cement content and a low content of an engineered emulsion with high maltenes (high penetration/low viscosity) could be used to utilize best qualities of both materials. An adequate amount of cement could enhance the layer strength/stiffness, whereas the relatively soft emulsion could help in the dispersion of cement, hydration, and lowering the potential of cracking of the mix.

### Objective and Scope of Work

The objectives of this study were to investigate the use of different curing periods and mixes with and without Engineered Emulsion (EE) to reduce variability and the cracking potential of cement-FDR mixes. The scope of work consists of the preparation and testing of cement FDR mixes with and without EE, cured and conditioned for different times, and evaluation of strength (UCS), cracking potential (image analysis), and mineralogy (X-Ray diffraction, XRD).

### Background

FDR addresses several structural deficiencies deep within the pavement structure, with typical pulverization depths ranging from 4 in. to 12 in. Suitable candidates for FDR include pavements with severe rutting, transverse thermal cracking, longitudinal cracking, alligator cracking, edge cracking, raveling, potholes, bleeding, bumps, oxidation, and polishing. The successful use of FDR can result in a significant reduction of life cycle cost compared to other rehabilitation strategies. However, there is a knowledge gap regarding the balancing of strength/stiffness and durability of FDR mixes. Mixes stabilized with asphalt emulsion may be susceptible to deformation and moisture damage, whereas those stabilized with cement may be prone to excessive cracking and premature deterioration.

This knowledge gap is critical considering ever-increasing extreme weather events, traffic volume, and load, which demand layers with high stiffness to ensure good-performing and long-lasting pavements. The increased occurrence of extreme weather events, such as high temperatures and heavy rainfalls or dry periods and a greater number of freeze-thaw cycles, coupled with the ever-increasing truck traffic, requires the construction of well-performing pavements with sufficient durability to resist the impacts of the environment. Premature failures of pavements not only lead to excessive maintenance costs but also cause user delays and an overall negative impact on the regional and national economies.

In a typical asphalt pavement, a significant portion of the structural capacity (>60%) is provided by the base course. FDR is a sustainable process of recycling existing aged asphalt pavements with granular base to well-performing and durable base courses with a minimized thickness of surface hot mix asphalt (HMA) layers. Traditionally, FDR is conducted by stabilizing the existing HMA layer and a predetermined thickness of the granular layer below it with an additive such as foamed asphalt or asphalt emulsion, with Portland cement or with cement only. Although they provide a very sustainable option of pavement recycling, both asphalt and cement stabilized FDR have their shortcomings, which, if overcome, could lead to significant advancements in sustainable pavement recycling.

For asphalt-stabilized FDR, some of the major concerns are obtaining adequate stiffness, maintaining stiffness under wet (moisture) conditions, and achieving sufficient early strength due to the need for curing. While the addition of cement could alleviate some of these problems, typical specifications prohibit the use of cement over 1.5% to prevent shrinkage cracks

Cement-stabilized FDR has worked well in many parts of the country. High stiffness of the cement stabilized FDR is particularly desirable to counter extreme weather events, and at the same time withstand ever-growing heavy loads and traffic. However, in addition to the need for the provision of adequate curing time, one of the major concerns in such FDR mixes is the occurrence of shrinkage cracks. The most prevalent technique that has been attempted to mitigate such cracking is microcracking before complete curing. However, this is not always a preferred method since it involves an additional construction step, and the results of attempts to reduce cracks by microcracking have been mixed, with sometimes negative results.

Therefore, there is a need to develop a mix that could overcome the problem of excessive cracking due to high stiffness—an optimized mix that could provide high stiffness under extreme weather events and at the same time be resistant to shrinkage cracking, and preferably does not require a relatively long curing time.

### Materials and Methods

A locally available reclaimed asphalt pavement (RAP, binder content of 6.7%) and a non-plastic base course material (Table 1) were combined in a 30:70 ratio as the FDR mix. Ordinary Portland cement (Type I/II) was used as the stabilizer. A 5% cement content was selected as a moderately high amount that would potentially yield a moisture-conditioned UCS in the range of 300-500 psi after 7 days of curing. This was verified by obtaining an average moisture-conditioned UCS of 405 psi for 5% cement-FDR mix. The optimum moisture content (OMC) of the FDR mix with 5% cement was determined to be 8%, with a maximum dry density of 140 pcf. The Engineered Emulsion contained 55% maltenes by weight of the asphalt, with the total percentages as follows: 35% water, 42% asphalt, and 23% maltenes.

TABLE 1
Gradation of the base and RAP materials

| Sieve size, mm | % Passing, Base | % Passing, RAP |
|---|---|---|
| 50.0 | 100 | 100 |
| 37.5 | 94 | 100 |
| 25 | 80 | 97 |
| 19 | 72 | 94 |
| 12.5 | 59 | 83 |
| 9.5 | 51 | 72 |
| 4.75 | 40 | 44 |
| 2.36 | 30 | 23 |
| 1.19 | 21 | 13 |
| 0.6 | 15 | 7 |
| 0.3 | 9 | 3 |
| 0.15 | 6 | 1 |
| 0.075 | 3.1 | 0.3 |

The samples were prepared, cured, and moisture conditioned according to the Texas Department of Transportation (DOT) specification, Tex-120-E. A range of “conditioning” was used, as shown in Table 2, to investigate the effect of curing periods, sequence of curing, and moisture conditioning on the strength of the samples. These included a dry “counter-top” conditioning period at room temperature.

TABLE 2
Conditioning procedures

| Conditioning | Procedure |
|---|---|
| Curing | Store the compacted specimens the same day as molded with the top and |
| | bottom porous stones in an environment with a minimum humidity of 95% |
| | for seven days. |
| Moisture | Place the specimens with the bottom porous stone only into the container of |
| conditioning | adequate height and volume to completely submerge the compacted |
| | specimens. Fill the container to approximately ½ to 1 in. above the top of |
| | the specimens with tap water in a manner that does not disturb and contact |
| | the specimens. Soak each specimen in the container for 24 hr. ± 1 hr. |
| Counter-top | Store the compacted specimen on a laboratory countertop at room |
| conditioning | temperature. |

Selected samples were also tested for their mineralogical composition, particularly the presence of CSH and CH, using X-Ray Diffraction (XRD) method. A Panalytical X'Pert Pro MPD powder X-ray diffractometer was utilized with tube voltage of 40 kV, tube current of 45 mA, and a continuous scanning mode within a controlled temperature ranging from 30° C. to 900° C.

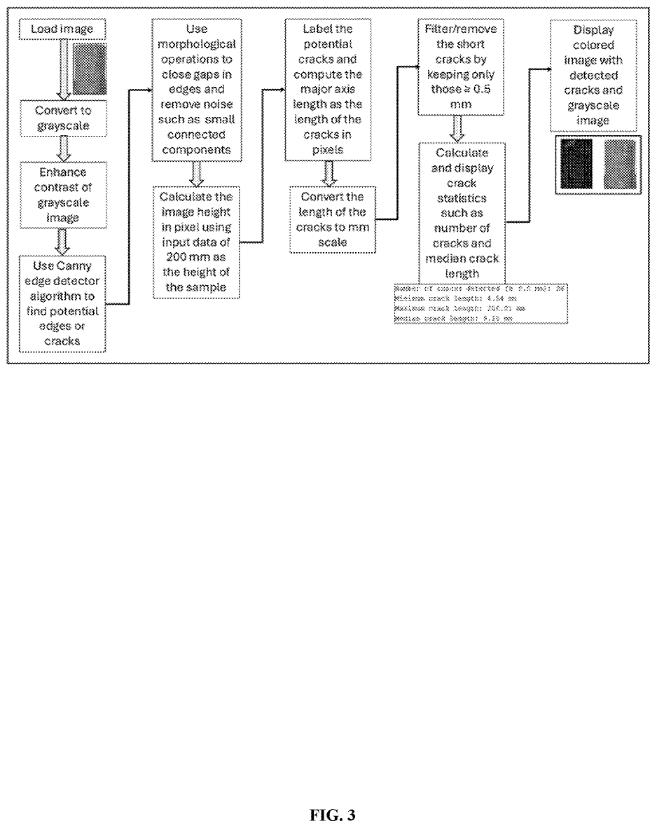

To evaluate the cracking potential, images of samples after curing and conditioning were analyzed to detect cracks after converting them to grayscale format. A MATLAB code was utilized to analyze cracks on a cylindrical object (concrete cylinder) using a 2D image and converting pixel measurements into real-world millimeter (mm) units based on known object dimensions (200 mm height of the sample). The number of cracks and the median size of cracks were then calculated for each image of the samples. Whenever possible, three replicates were used for each set of samples. FIG. 3 shows the main steps of the method.

### Results and Analysis

### Effect of Curing Periods

One of the biggest concerns about FDR is the provision of an adequate “curing” period for asphalt and cement stabilization. This period is deemed to be necessary for the development of adequate strength before opening the roadway to traffic. For cement stabilized FDR, a moist curing period of up to seven days is often specified, which, if reduced, can help road agencies to reduce traffic delays and detours, and hence reduce the negative impact on the transportation system. Therefore, one pertinent question is, for FDR mix with a moderate cement content that can provide a UCS of 300-500 psi (post moisture conditioned), is there a significant difference in UCS between mixes subjected to different curing periods? The question arises because one can argue that for high water/cement ratio mixes (8% OMC, 5% cement, w/c ratio of 1.6, compared to typical w/c of cement concrete of 0.4-0.6; c/w ratio of 0.6 compared to typical ratios of 1.7-2.5 in cement concrete), most of the hydration reactions should occur within a relatively short period compared to mixes with low water/cement ratio.

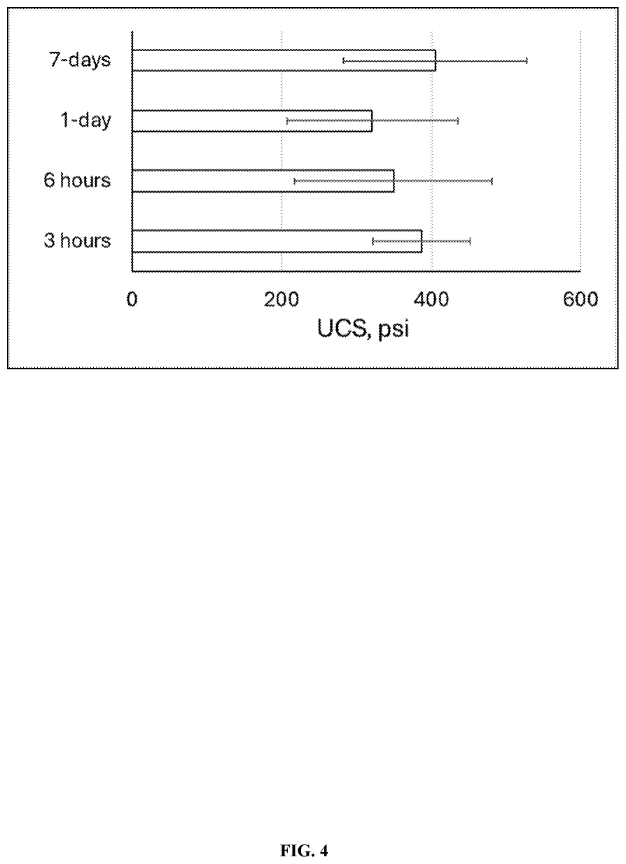

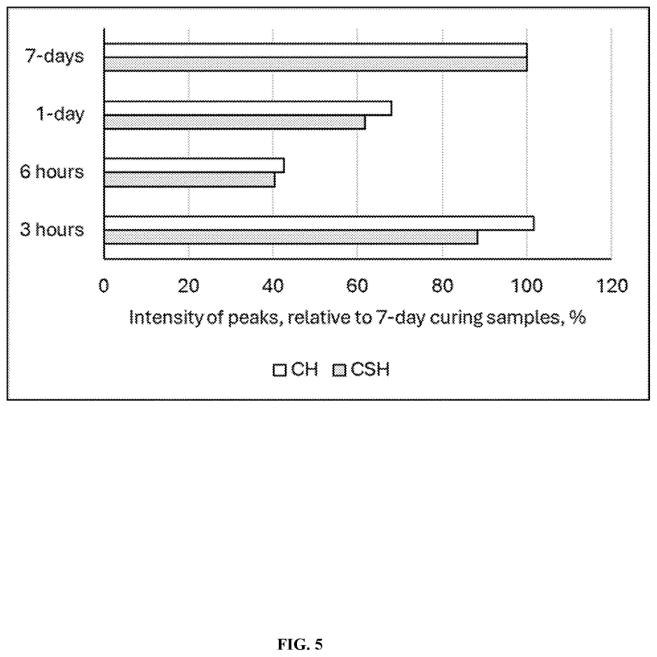

FIG. 4 compares the UCS results of samples of the same mix cured for different durations before being subjected to moisture conditioning by immersion. No statistically significant difference in results was observed between the mixes cured for 3 hours, 6 hours, 24 hours, and 7-day curing. FIG. 5 shows the CH and CSH peaks (relative to 7-day curing) from the XRD tests. Note that these results are from mixes that were subjected to curing and then moisture conditioning. The relatively high CH and CSH intensities at 3 hours curing could be because when concrete is immersed in water, the curing process is generally enhanced, especially during the early stages of hydration. This is because water immersion ensures a constant supply of moisture, maintains a stable temperature, and reduces the potential of shrinkage cracking due to the evaporation of water. The water immersion process may not be as effective after 6 hours of curing as it is after 3 hours of curing. After 1 day of curing, greater amounts of CH and CSH are formed compared to the 6-hour cured mixes, although the difference does not seem to have any effect on the UCS values (they are not significantly different, as seen in FIG. 4).

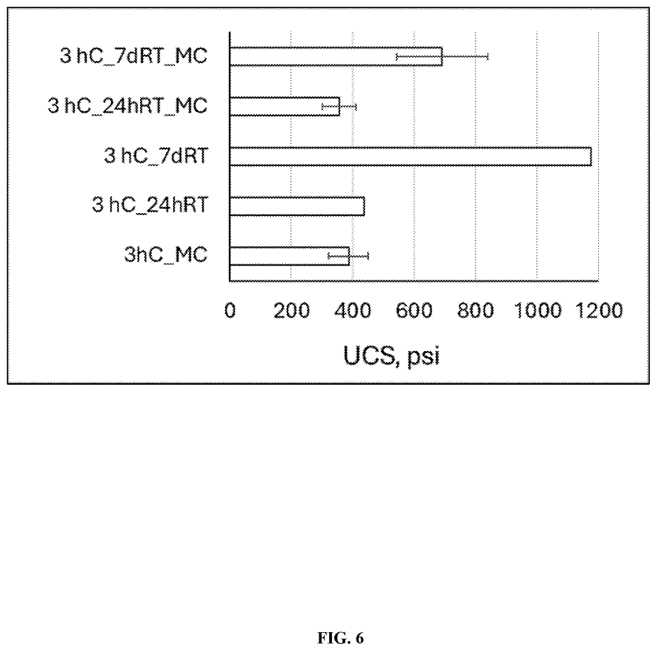

FIG. 6 presents the UCS data of mixes that were all cured for 3 hours and then subjected to different processes thereafter. The means of groups 3 hC MC and 3 hC 7dRT MC are significantly different. Keeping the sample on the countertop at room temperature for 7 days after 3 hours of curing results in a significant increase in UCS compared to 3 hours of curing only. There seems to be no difference in UCS between 3-hour cured, 24-hour countertop mixes with and without moisture conditioning; however, moisture conditioning does seem to result in a decrease in UCS for samples that were cured for 3 hours and kept on the countertop for 7 days. One observation is that curing for 3 hours and leaving it exposed to air for 7 days before moisture conditioning will produce a mix that has a higher retained strength than a mix that is subjected to 7 days of curing and then moisture conditioning.

These results are most likely indicative of the interactions between the curing period, the time of moisture conditioning, which may help in the hydration process in early curing periods by supplying a constant source of water and stable temperature, and the resulting potential of shrinkage cracks.

### Effect of Engineered Emulsion (EE)

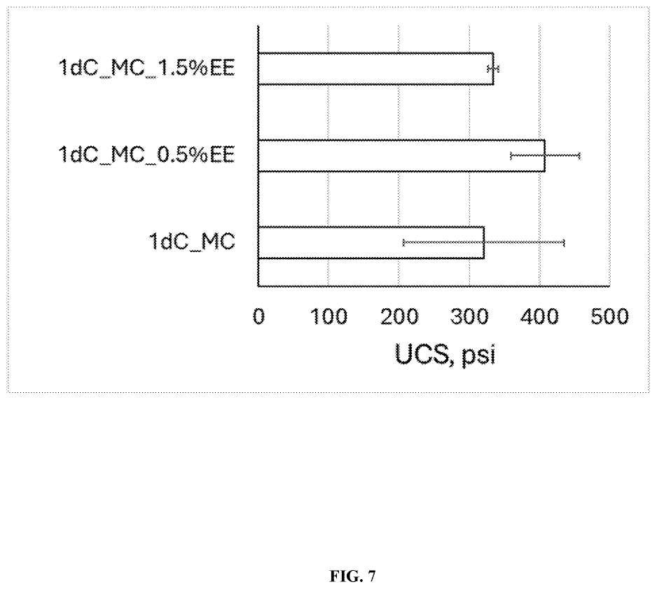

FIG. 7 shows the UCS values of three mixes cured for the same duration of 1 day and then subjected to moisture conditioning: no EE, 0.5% EE and 1.5% EE. There is no significant difference in UCS between mixes with and without EE. However, the standard deviation is significantly reduced with the use of EE; it drops from 114 psi for no EE to 49 psi for 0.5% EE, and 7 psi for 1.5% EE. This can be primarily because of two reasons: 1. The emulsion acts as a medium to facilitate the dispersion of cement within the FDR mix; 2. The availability of the liquid emulsion medium helps in the hydration process. This second point is confirmed with the presence of relatively higher amounts of CH and CSH in the mixes with emulsion, as shown in FIG. 5. The reduction in variability of the UCS values (and hence, a reduction in stiffness values) has a significant impact on the reduction in variability and, hence an increase in reliability in the structural design of pavements with FDR layers. A third reason might be a reduction in the potential of concentrated large cracks with the use of the emulsion—this aspect is discussed later.

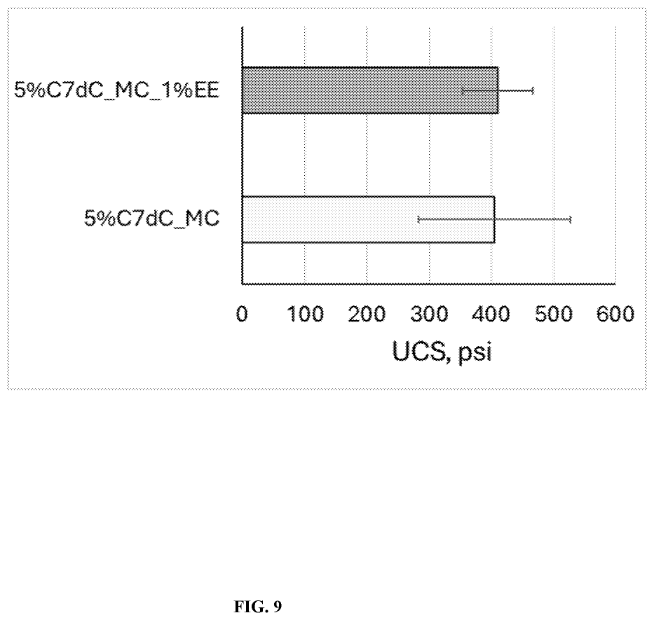

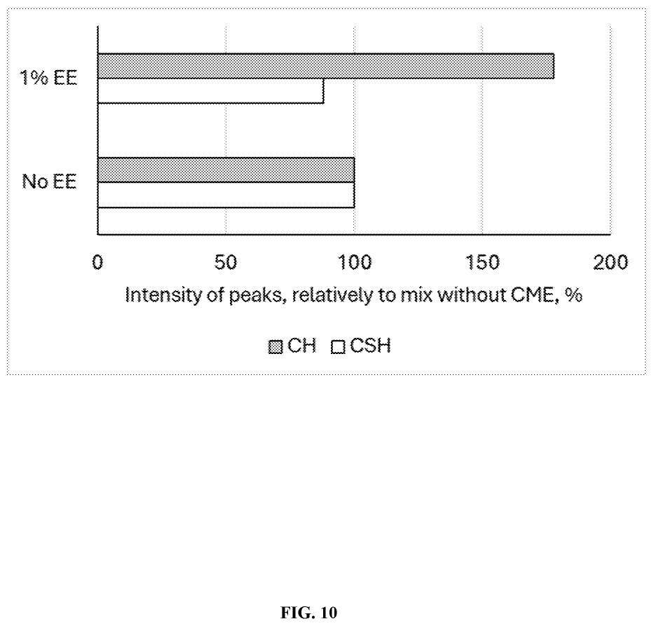

FIG. 9 shows the comparison of UCS values of mixes with no EE and 1% EE, both subjected to 7-day curing and moisture conditioning. There is no statistically significant difference between the results. However, the addition of 1% EE seems to have reduced the standard deviation of the UCS values significantly. FIG. 10 shows a comparison of the CH and CSH present in these mixes. The CSH values are almost identical, whereas a higher value of CH is observed for the 1% EE mix. This is likely due to the higher availability of water (from the emulsion) for the EE mix that enhances the hydration process and the CH formation, which is more sensitive to the availability of water than the CSH formation.

### Impact of Reduced Variability on Structural Design

The resilient modulus of the cement-FDR mixes was estimated from the UCS values from the following equation (10).

$$Resilent Modulus , ksi = 36.5 * \sqrt{UCS , psi} \qquad ( 1 )$$

The average and standard deviation values were utilized in Montecarlo simulations (10⁶) to estimate the probable distributions of the cost of the asphalt layer that would be required in a pavement to support 10 million standard load applications of 80KN dual tire axles. Equations 2-4 were used for general analysis from Austroads, considering the tensile strains at the bottom of the asphalt mix layer and the cement-treated base layers, and the compressive strains at the top of the subgrade layer. The Austroad models were utilized because of the well-validated tensile strain-based fatigue failure criterion for cement-treated base course layers. The cross section of the pavement consisted of an asphalt mix layer over 8-inch cement-FDR base, 8 inch of granular base with a modulus of 30 ksi, and a subgrade with a CBR of 5. The asphalt mix has a modulus of 360 ksi, with performance exponent, constant, and shift factor of 5, 0.004342, and 6, respectively (see equation 2). The cost of the asphalt mix layer was considered to be $6.00 per inch, per square yard.

$${N}_{fAC} = \frac{SF}{RF} {( \frac{k}{ε} )}^{b} \qquad ( 2 )$$

$${N}_{fCTB} = {RF ( \frac{k}{ε} )}^{12} \qquad ( 3 )$$

$${N}_{r} = ( {( \frac{0.00915}{ε} )}^{7} \qquad ( 4 )$$

where, N_{fAC}=number of repetitions to fatigue failure due to tensile strain at the bottom of the asphalt mix layer; N_{fCTB}=number of repetitions to fatigue failure due to tensile strain at the bottom of the cement-treated base layer; Nᵣ=number of repetitions to rutting failure due to compressive strain at the top of the subgrade layer

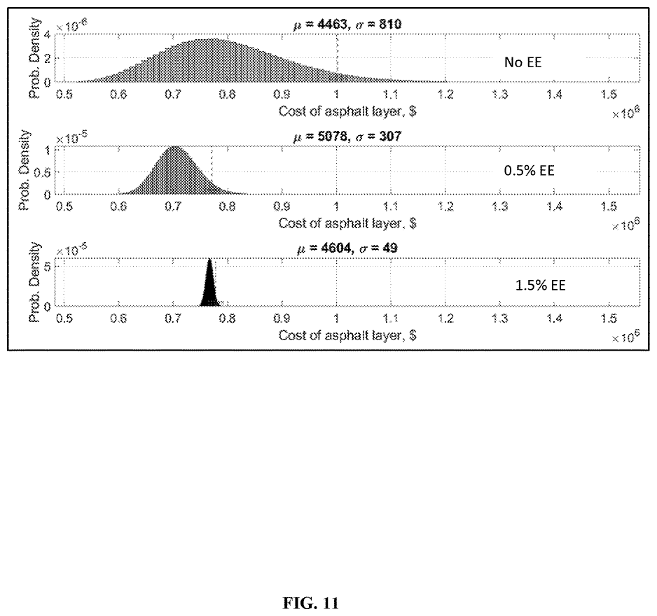

The simulation results (FIG. 11) clearly show the significant impact of the higher variability in the modulus values of the non-EE mix on the expected distribution of the cost of the asphalt mix layer that will be required. A higher variability of the modulus of the base course will result in a higher variability of the thickness of the asphalt mix layer, and hence a higher variability of the cost of the asphalt mix layer. The 95th percentile values for the no-EE mix, and both 0.5% EE and 1.5% EE mixes are approximately $1 million and $800,000, respectively.

Correlation of CSH and CH Content with UCS

Since CH and CSH are the primary hydration products that contribute towards strength development, it is expected that their intensities should show some relationship with the UCS results of the cement-FDR mixes. FIGS. 9 and 10 show the data with the fair regression models, which were conducted with the mixes without EE; the data for the EE mixes are also indicated on the plot. CSH shows a slightly better correlation (R²=0.64) compared to CH (R²=0.56). The relatively weak correlations are expected because of the presence of coated RAP and base materials, as compared to a more uniform mix with graded aggregates and cement only, for which higher correlations could be expected.

### Image Analysis for Evaluation of Cracking

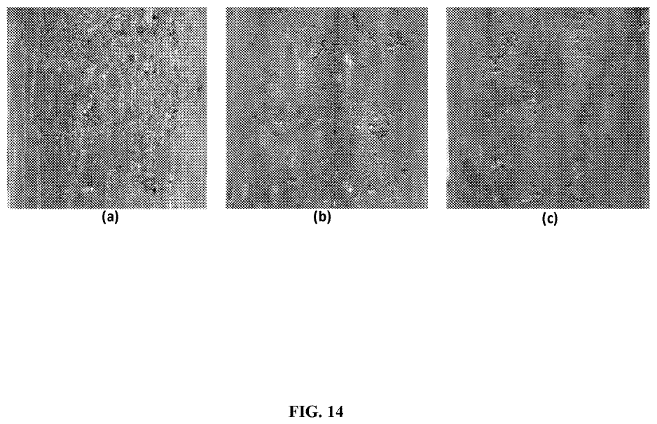

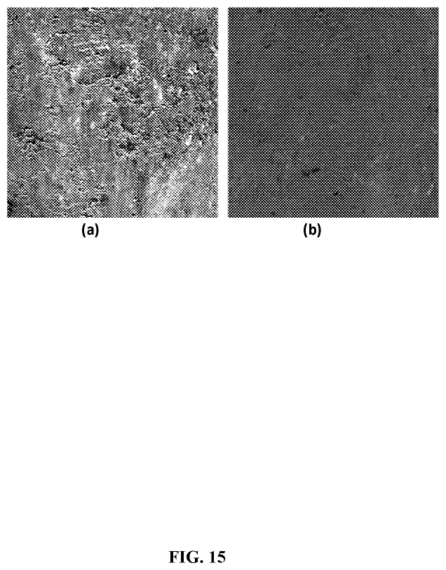

Images of the surface of typical samples of mixes with and without EE are shown in FIGS. 14 and 15. All of the mixes showed cracks on the surface, although the numbers and the sizes differed significantly.

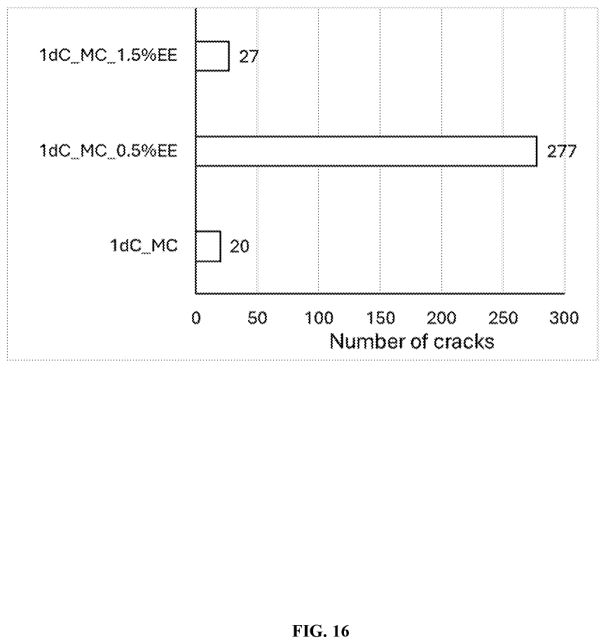

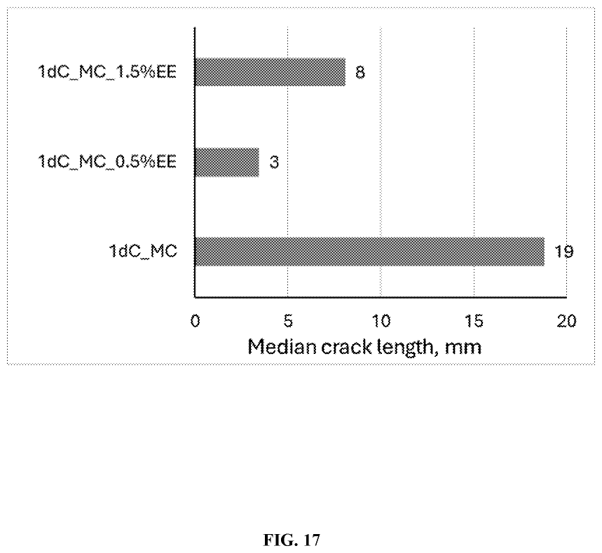

The images of pre-UCS samples were analyzed for cracks, and the number and median length of the cracks (>0.5 mm) were calculated (FIGS. 16 and 17). The number of cracks was significantly higher for the mix with 0.5% EE, while those of the mixes without EE and 1.5% EE were almost the same (20 and 27, respectively). However, the median crack length of the mixes varied significantly: 19 mm for the no EE mix, and 3 mm and 8 mm for the mixes with 0.5% and 1.5% EE, respectively.

### Failure Modes During UCS Tests

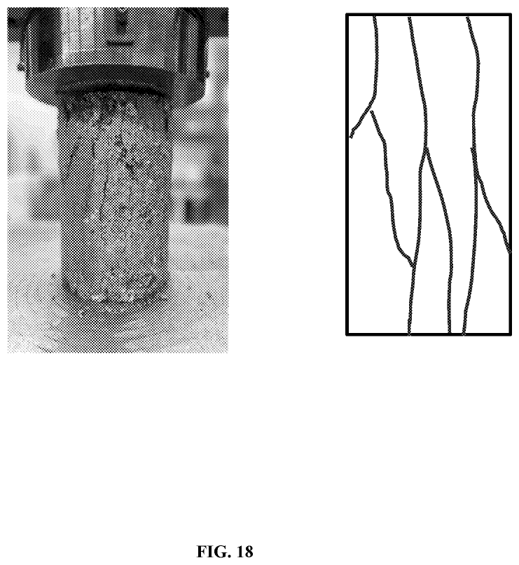

Samples of all mixes exhibited Type 3 failure mode during the UCS test (an example is shown in FIG. 18). This similarity in failure, which is characterized by an inclined fracture or diagonal shear plane, indicates similarity in the mechanical behavior of the mixes under loading. The Type 3 failure also indicates that the failure is due to the inherent shear and tensile properties of the mixes, and not due to any flaws in testing.

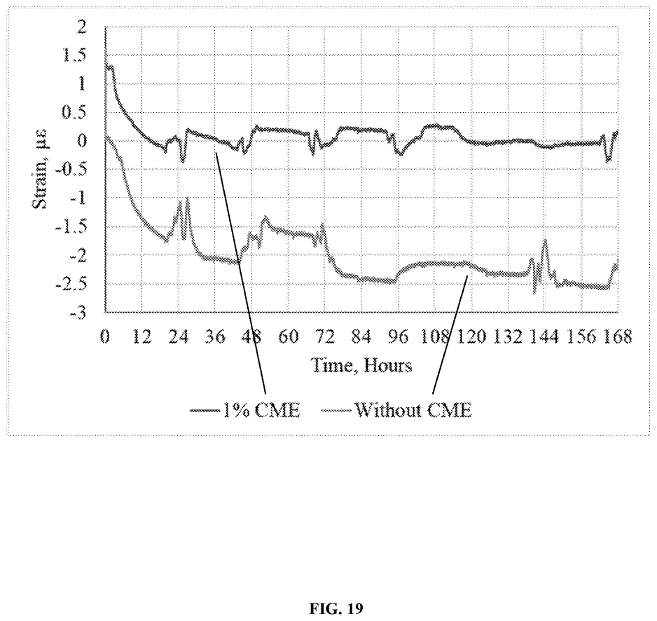

FIG. 19 shows shrinkage cracking potential of adding crack mitigating agent. A mix (FDR Mix, 30% RAP, 70% Base, 5% Type I/II Cement, W/C ratio, 1.6) with 1% CME shows significantly less (almost 0) strain, indicating much lower tensile stress, and hence cracking potential, compared to conventional cement only mix. The 7-day moisture conditioned UCS (psi) for the mix without CME was an average of 639 with STDV of 98. The 7-day moisture conditioned UCS (psi) for the mix with 1% CME was an average of 420 with STDV of 59.

### Conclusions and Recommendations

1. The length of curing from 3 hours, 6 hours, 1 day, and 7 days does not make any difference in terms of moisture conditioned UCS for a cement content of 5%.
2. The amount of CH and CSH could be identical for mixes cured for different times
3. Mixes subjected to 3 hours of controlled curing and 7 days of room temperature curing had higher moisture-conditioned UCS values compared to mixes with 7 days of controlled curing
4. The presence of EE can significantly reduce the variability of the UCS results without lowering the average value
5. Addition of EE can lead to enhancement of CH and CSH formation in cement-FDR mixes
6. A reduced variability of stiffness can lead to a reduced variability of asphalt layer thickness and cost
7. CSH shows a slightly better correlation with UCS of cement-FDR mixes compared to CH
8. Mixes with EE, cured for 24 hours, show a significantly lower median crack length compared to mixes without EE.
9. A more comprehensive study is warranted to explore the use of EE as a crack mitigator, and for better dispersion and reduction of variability of strength in cement-FDR mixes.

It should be understood that the disclosure of a range of values is a disclosure of every numerical value within that range, including the end points. It should also be appreciated that some components, features, and/or configurations may be described in connection with only one particular embodiment, but these same components, features, and/or configurations can be applied or used with many other embodiments and should be considered applicable to the other embodiments, unless stated otherwise or unless such a component, feature, and/or configuration is technically impossible to use with the other embodiment. Thus, the components, features, and/or configurations of the various embodiments can be combined together in any manner and such combinations are expressly contemplated and disclosed by this statement.

It will be apparent to those skilled in the art that numerous modifications and variations of the described examples and embodiments are possible considering the above teachings of the disclosure. The disclosed examples and embodiments are presented for purposes of illustration only. Other alternate embodiments may include some or all of the features disclosed herein. Therefore, it is the intent to cover all such modifications and alternate embodiments as may come within the true scope of this invention, which is to be given the full breadth thereof.

It should be understood that modifications to the embodiments disclosed herein can be made to meet a particular set of design criteria. Therefore, while certain exemplary embodiments of the compositions, materials, apparatuses, and methods of using and making the same disclosed herein have been discussed and illustrated, it is to be distinctly understood that the invention is not limited thereto but may be otherwise variously embodied and practiced within the scope of the following claims.

A number of implementations have been described. Nevertheless, it will be understood that various modifications may be made without departing from the spirit and scope of the disclosure. Accordingly, other implementations are within the scope of the following claims.

1. A method of preparing a roadway material, the method comprising:
combining an aggregate and a binder to form an untreated roadway mix, the binder including cement;
adding a crack mitigating agent to the untreated roadway mix to form a treated roadway mix, the crack mitigating agent includes maltenes, the amount of maltenes within the crack mitigating agent being 0.01%-5% by weight of the untreated roadway mix.

2. The method of claim 1, wherein:
the aggregate includes one or more types of aggregate; and/or
the binder includes one or more types of binder.

3. The method of claim 1, wherein:
the crack mitigating agent is added during and/or after the aggregate and the binder are combined to form the untreated roadway mix.

4. The method of claim 1, wherein:
the aggregate includes stone, gravel, crushed concrete, and/or recycled asphalt pavement (RAP).

5. The method of claim 1, wherein:
the binder includes asphalt.

6. The method of claim 1, wherein:
the cement is Portland cement.

7. The method of claim 1, wherein:
the cement in the binder is at least 1% by weight of the untreated roadway mix.

8. The method of claim 1, wherein:
the crack mitigating agent is an emulsion.

9. The method of claim 9, wherein:
the emulsion includes water, asphalt, and maltenes.

10. The method of claim 9, wherein:
the emulsion is 1%-60% maltenes by weight of the emulsion.

11. The method of claim 1, wherein:
the crack mitigating agent is added to the roadway mix all at once, in a gradual adding process, or in an iterative process.

12. A method of conditioning an untreated roadway mix, the method comprising:
adding a crack mitigating agent to an untreated roadway mix, the crack mitigating agent includes maltenes, the mount of maltenes within the crack mitigating agent being 0.01%-5% by weight of the untreated roadway mix;
wherein the untreated roadway mix includes a binder or a binder is added to the untreated roadway mix prior to adding the crack mitigating agent, the binder including cement.

13. The method of claim 12, wherein:
the untreated roadway mix is or includes a cement-stabilized roadway mix.

14. The method of claim 12, wherein:
the untreated roadway mix comprises:
recycled asphalt pavement (RAP); and/or
aggregate base course.

15. The method of claim 14, wherein:
the aggregate base course includes stone, gravel, and/or crushed concrete.

16. The method of claim 12, wherein:
the untreated roadway mix comprises:
recycled asphalt pavement (RAP); and
aggregate base course.

17. The method of claim 16, wherein:
the untreated roadway mix has a greater percentage of aggregate base course than that of RAP.

18. The method of claim 16, further comprising:
adding water to the treated roadway mix such that a moister content of the treated roadway mix is greater than the predetermined optimum moisture content of the untreated roadway mix.

19. A method of processing roadway material, the method comprising:
reclaiming one or more layers of a roadway material comprising an asphalt layer and a base course layer to form an untreated roadway mix;
adding a binder comprising cement to the untreated roadway mix;
adding maltenes to the untreated roadway mix to generate a treated roadway mix by influencing:
dispersion of the cement in the treated roadway mix;
formation of calcium hydroxide (CH) and/or calcium silicate hydrate (CSH) in the treated roadway mix; and/or
flexibility of the treated roadway mix.
